(19) United States
(12) Patent Application Publication
(10) Pub. No.: US 2023/0392998 A1
(43) Pub. Date: Dec. 7, 2023

(54) Force Sensing Device

(71) Applicant: Peratech Holdco Limited, Catterick Garrison (GB)

(72) Inventors: Thomas Benjamin MITCHELL-WILLIAMS, Durham (GB); Apostolos Theocharis Voutsas, Vancouver, WA (US)

(21) Appl. No.: 18/234,844

(22) Filed: Aug. 16, 2023

Related U.S. Application Data
(63) Continuation of application No. PCT/GB2022/000021, filed on Feb. 15, 2022.

(30) Foreign Application Priority Data
Feb. 16, 2021 (GB) 2102134.0

(51) Int. Cl. G01L 1/14; G01L 1/22

(52) U.S. Cl. CPC G01L 1/142; G01L 1/22

(57) ABSTRACT

A force sensing device comprises a first electrode and a second electrode and a substrate comprising at least one groove. The force sensing device further comprises an active material between the first and second electrodes. The at least one groove comprises a first face and a second face inclined to the first face. The first face and second face are arranged a distance apart from each other. The first electrode is deposited on the first face and the second electrode is deposited on the second face. The distance changes on application of an applied force to deform the active material and provide a change in an electrical property, such as resistance, capacitance or a combination, of the active material.

### CROSS REFERENCE TO RELATED APPLICATIONS

This application is a continuation of and claims priority to International Patent Application number PCT/GB2022/000021, filed on 15 Feb. 2022, which claims priority from United Kingdom Patent Application number 21 02 134.0, filed on 16 Feb. 2021. The whole contents of International Patent Application number PCT/GB2022/000021 and United Kingdom Patent Application number 21 02 134.0 are incorporated herein by reference.

### BACKGROUND OF THE INVENTION

The present invention relates to a force sensing device, an electronic device comprising a force sensing device and a method of manufacturing a force sensing device.

Force sensing devices are known to comprise matrix-style arrays of sensing elements or sensels arranged directly beneath a flexible “A” surface to form an electronic device such as a trackpad or flexible or foldable display.

Beneath the “A” surface an active material is provided in combination with two electrodes to generate an output signal (such as the resistance of the force sensing device) in response to an applied force. The presence of the “A” surface is known to prevent large displacements and dilute the transfer of force to the sensing elements. Consequently, the sensing elements need to be sensitive to both small displacements and small forces, without compromising on the dynamic range of the force sensing device.

Previous solutions have included pre-loading force sensing devices to increase sensitivity to the first touch by reducing the subsequent deformation needed to achieve a change in the output signal. Pre-loading may also be used to compensate for integration tolerances in manufacture. In some cases, sensor assemblies may be oversized and subsequently pre-loaded during installation to overcome the manufacturing tolerances. However, this process of pre-loading can reduce the dynamic range of the force sensing device.

In addition, the design of conventional force sensing devices requires a further “B” surface opposite to the “A” surface in order to provide a reaction force to enable a force on the “A” surface to be measured by means of compression of the active material.

Further, on application of a force, the active material may reduce in thickness while increasing in a lateral direction. This further means that lateral expansion gaps and/or suitable patterning of the active material must be incorporated into current force sensing devices between the sensing elements, thereby limiting the pitch of the array.

JP 2005 091106 A (JAPAN SCIENCE & TECH AGENCY) published 7 Apr. 2005 describes a two-dimensional distribution type force sensor capable of detecting the force in normal direction or tangential direction. The force sensor comprises a V groove formed on a base and electrodes formed on both sides of the V groove. A cylindrical force sensing material is separated by an air gap and can be brought into contact with the electrodes on application of a force.

### BRIEF SUMMARY OF THE INVENTION

According to a first aspect of the present invention, there is provided a force sensing device.

According to a second aspect of the present invention, there is provided a method of manufacturing a force sensing device.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an example electronic device incorporating a trackpad comprising a force sensing device;

FIG. 2 shows a schematic perspective view of a substrate for a force sensing device;

FIG. 3 shows a cross-sectional view of the substrate of FIG. 2;

FIG. 4 shows the substrate of FIG. 3 following the deposition of a plurality of electrodes;

FIG. 5 shows the substrate in combination with an active material;

FIG. 6 shows the deposition of an encapsulant;

FIG. 7 shows a groove of the substrate in a rest configuration; and

FIG. 8 shows the groove of FIG. 7 on application of a force.

### DETAILED DESCRIPTION OF EMBODIMENTS OF THE INVENTION

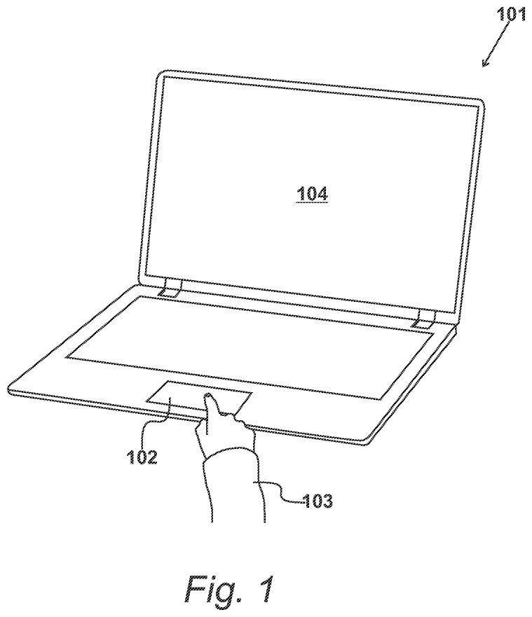

### FIG. 1

An example electronic device is illustrated in FIG. 1. Electronic device 101 comprises a laptop computer comprising a trackpad 102. Trackpad 102 can be utilized by user 103 to provide an input to electronic device 101, such as by providing an input which is configured to move a cursor on the display 104 of electronic device 101. To affect this, trackpad 102 comprises a force sensing device.

Trackpads of this type may therefore include force sensing devices and processing means configured to convert a pressure input signal to the trackpad (and force sensing device) to an output signal to display 104. Conventional force sensing devices which may be utilized in such an application typically comprise parallel planar surfaces, with electrodes on opposing faces and coplanar with each other. Thus, in such an arrangement, a plurality of layers are arranged parallel to each other with a first electrode and a second electrode arranged with a layer of active material therebetween. In such devices, the active material may be a quantum tunnelling material, such as that available from the present applicant under the name QTC®, which is a material which displays a piezoresistive response such that the material experiences a change in resistance in response to an applied force.

With such conventional force sensing devices, the planar arrangement of electrodes means that dilution of an applied force can occur when the force sensing device is integrated below an “A” surface, such as a display or top surface of the trackpad shown in the example. In some cases, this can mean that a light press does not activate the force sensing device adequately. In addition, a further hard bottom surface is also necessary to provide a complementary compressive force to ensure actuation.

While the example embodiment described here in FIG. 1 illustrates a laptop computer and trackpad, it is appreciated that the invention described herein may further be utilized in respect of alternative electronic devices, such as, but not limited to, mobile telephones, tablet computers, touch screen displays or other touch input devices.

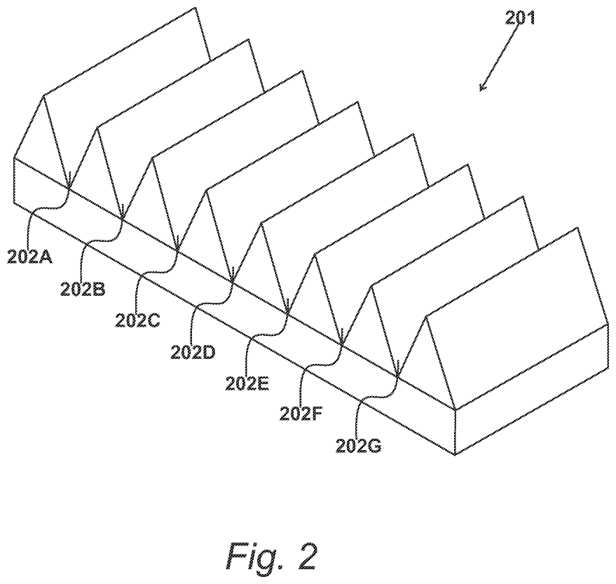

### FIG. 2

To address these issues, the present invention provides an improved force sensing device for incorporating into such scenarios to improve the response from the force sensing device and reduce complexity of introducing compensating features during manufacture, which can affect tolerances.

A force sensing device which is suitable for use with an electronic device, such as electronic device 101 comprises a substrate 201. The force sensing device described herein may therefore be suitably integrated into electronic device 101 as described with respect to FIG. 1.

Substrate 201 comprises at least one groove, and, in this illustrated embodiment, comprises a plurality of grooves 202. In the embodiment, substrate 201 comprises seven such grooves, however, it is appreciated that any other number of suitable grooves may be utilized, depending on the application in question and dimensions of the force sensing device and consequently the substrate itself.

In the embodiment, substrate 201 comprises a flexible non-conductive material. Substrate 201 may therefore be any suitable flexible non-conductive material, examples of which include those which comprise a polymer material.

The groove or plurality of grooves are formed by any suitable additive or subtractive manufacturing process. In an embodiment, the at least one groove is formed in substrate 201 by an embossing process. The embossing process comprises embossing the surface of a suitable polymer material, such as a thermoplastic material, using heat and pressure while passing the substrate through a patterned metal rollers to form the substrate comprising at least one groove. Similar embossing techniques may also be anticipated as forming part of the invention.

In an alternative embodiment, a resin mixture may be photo-cured into a pattern comprising at least one groove by means of a textured roller and template. The resin mixture may comprise a UV curable resin which is passed between the patterned roller and a carrier sheet having a release sheet thereon. Where the resin and textured roller make contact, UV light is used to cure the required shape (grooves) into the UV curable resin. It is appreciated that other suitable micro-embossing techniques may also be suitable to form the substrate as described herein.

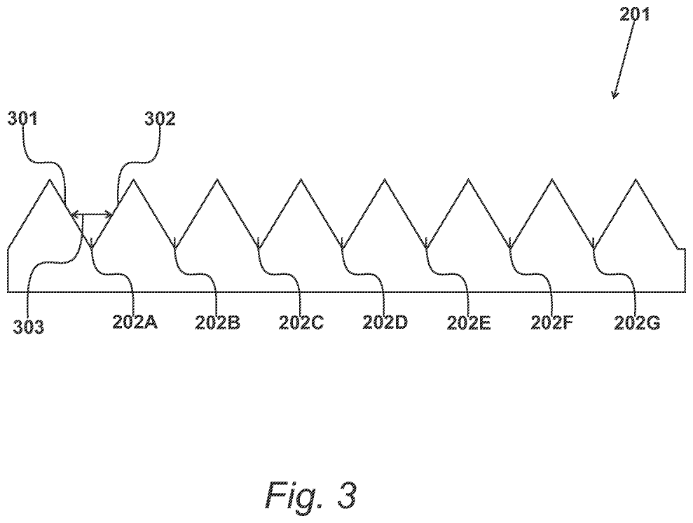

### FIG. 3

A cross-sectional schematic view of substrate 201 is shown in FIG. 3. The plurality of grooves 202 are shown and each groove comprises a substantially similar cross-sectional shape. In the embodiment, the plurality of grooves provides a substantially saw-tooth cross-sectional shape in which each groove comprises a triangular cross-section. It is appreciated that the grooves may have alternative cross-sectional shapes such as, but not limited to, a curved U-shape or V-shape or a rectangular profile.

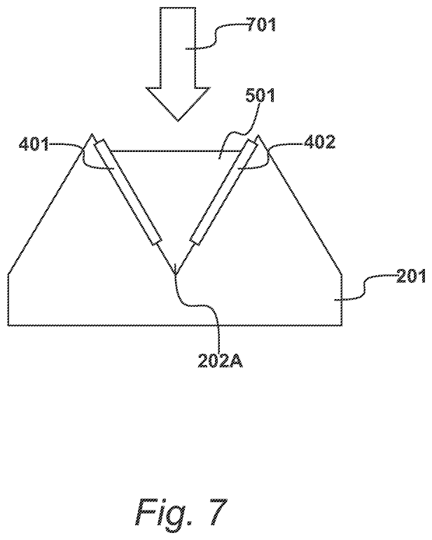

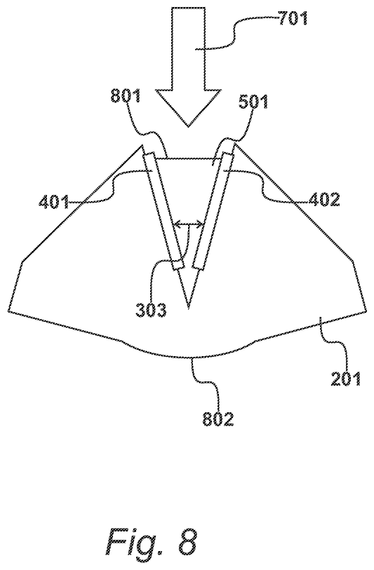

In each embodiment, however, each groove comprises a first face and a second face which are inclined to each other. Specifically, referring to groove 202A, groove 202A comprises face 301 and face 302, with face 302 being inclined with respect to face 301. Faces 301 and 302 are arranged a distance 303 apart from each other. As will be explained further with respect to FIGS. 7 and 8, on application of a force, distance 303 is configured to change such that faces 301 and 302 move apart from each other, or closer together. It is therefore appreciated that any cross-sectional shape which allows this to occur would be suitable for use in accordance with the invention.

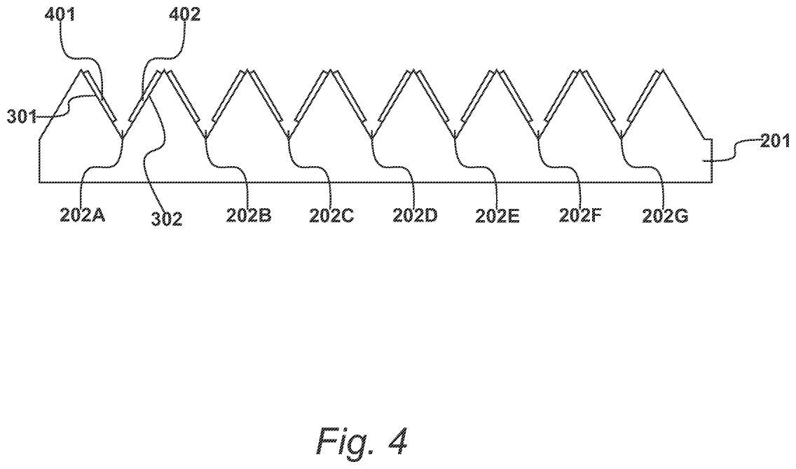

### FIG. 4

In manufacture, following the formation of substrate 201 as described with respect to FIGS. 2 and 3, electrodes are deposited onto the faces of each of the at least one groove.

Thus, again referring to groove 202A, a first electrode 401 is deposited onto face 301 and a second electrode 402 is deposited onto face 302. Similarly, each of the faces of the other grooves 202 receive a deposition of an electrode on their respective faces, which are arranged in a substantially similar manner to groove 202A.

In the embodiment, each of the electrodes 401, 402 comprises a conductive material. In an embodiment, such a conductive material comprises a metallic material. Suitable metallic materials for either electrode 401 or electrode 402 include metallic materials comprising aluminum, titanium or copper. In an embodiment, each pair of electrodes (i.e., those on opposing faces, such as electrodes 401 and 402), comprises a substantially similar metallic material. In an alternative embodiment, each pair of electrodes comprises different metallic materials.

In the embodiment, each said electrode may be deposited by any suitable manufacturing process, such as, but not limited to a physical vapor deposition process, an evaporation process, a pulse laser deposition process, a sputtering physical deposition process or molecular beam epitaxy. In order to ensure that the inclined faces 301, 302 are coated with the electrode material, and not the other parts of the groove 202A, a line-of-sight deposition is utilized and the angle of the source of the depositing material relative to the substrate 201 is controlled to ensure that only the inclined faces receive the electrode material.

Following the deposition of the electrode material, each pair of electrodes are disconnected from each other and are spaced apart by the nature of the faces of the grooves and do not touch while in the rest configuration (when no force is applied) as shown in FIG. 4.

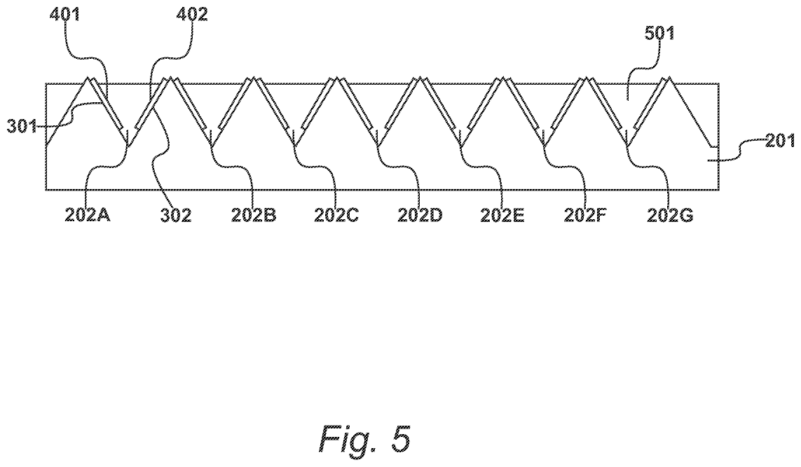

### FIG. 5

Once each pair of electrodes have been deposited onto their corresponding faces of each groove, an active material 501 is applied between each pair of electrodes.

As shown, the active material is applied to substrate 201 and when deposited onto substrate 201 positions into grooves 202 between each groove's respective faces. Consequently, active material 501 fills each of the at least one groove or plurality of grooves of the substrate in question. Each pair of electrodes 401, 402, are also consequently encapsulated by the active material 501 such that the pair of electrodes 401, 402 and active material 501 can function as a force sensing device.

In an embodiment, active material 501 comprises a suitable material for formation of a force sensing device. In particular, a choice of active material may determine the type of force sensing device formed. In an embodiment, a resistive mode sensing device is constructed when active material 501 comprises a piezoresistive composite such as a quantum tunnelling material composite, a porous conductive foam or a mesh comprising a plurality of conductive elastomeric fibers.

In an alternative embodiment, active material 501 comprises a flexible dielectric such as an elastomer or elastomer foam to form a capacitive sensing device.

In the embodiment, it may be desirable to utilize porous materials as active material 501. Porous materials advantageously reduce hysteresis and provide a faster response to applied force. Further, porous materials do not experience significant Poisson expansion as the compression under applied force is accommodated as a volume change. In addition, in the embodiment where active material 501 comprises a flexible dielectric to form a capacitive sensing device, the collapse of the pores during compression additively increases the signal measured by increasing the effective permittivity of the material.

In an embodiment where active material 501 comprises a composite material such as a quantum tunnelling material such as that available from the present applicant, Peratech Holdco Limited, Catterick Garrison, United Kingdom, under the name QTC®, measurement of an applied force is dependent on the starting resistance of the composite material when there is zero force. A small capacitive signal may be measured when a very small deformation force is applied, before switching to a resistance signal when higher forces occur in the force sensing device described herein.

Thus, when a force is applied, an electrical property can be measured from the active material to enable the force sensing device to function as a capacitive force sensing device (when the active material is an insulating material), a hybrid force sensing device exhibiting both capacitive and resistive sensing (when the active material is a composite material) or a resistive force sensing device (when the active material is a force sensing device).

In the embodiment, active material 501 comprises a lower elastic modulus than substrate 201.

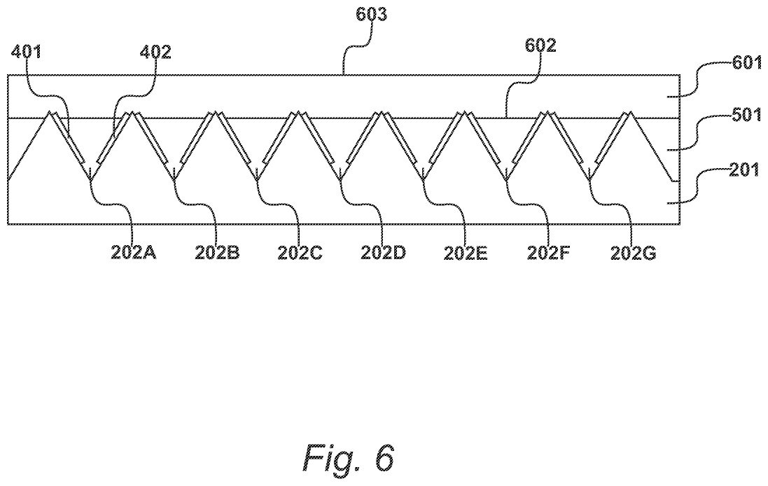

### FIG. 6

A force sensing device in accordance with the present invention may further comprise an encapsulant configured to prevent contamination of the force sensing device. Following application of the active material 501, an encapsulant 601 is further applied to an upper surface 602 of active material 501. Thus, the encapsulant 601 encapsulates the active material 501, the electrodes 401, 402 and grooves 202 to protect the force sensing device.

In the embodiment, the force sensing device is encapsulated against environmental contamination. The need for this purpose may vary depending on the application in which the force sensing device is utilized, however, the purpose of the encapsulant is to provide an environmental barrier to, for example, water or air ingress.

In a further embodiment, the encapsulant serves a dual purpose and comprises an adhesive. In this embodiment, the upper surface 603 of encapsulant 601 is configured to be attached to a surface of electronic device 101 to hold the force sensing device in position.

In an embodiment, the adhesive comprises a UV curable material, a thermally curable material or a polymer resin in a solvent system. It is appreciated that any other suitable encapsulating material may be utilized to retain a barrier to the force sensing device.

When the force sensing device is incorporated into an electronic device, as described in FIG. 1, for example, the encapsulant/adhesive functions to ensure that the force sensing device does not slide around on the surface of the electronic device to which it is attached. Ensuring a lack of slippage means that the force sensing device can function accurately in response to the applied force to the electronic device which is then transmitted to the force sensing device.

### FIG. 7

On application of an applied force, active material 501 is configured to deform and the distance 303 between faces 301 and 302 changes such that a change in an electrical property from active material 501 can be measured.

FIG. 7 shows a schematic of groove 202A in isolation and a direction of applied force 701 to be received. In the embodiment shown in FIG. 7, groove 202A is in a rest configuration. Thus, when reading an electrical signal from active material 501, the output signal will be consistent with the material at rest. Depending on the type of active material, as previously described with respect to FIG. 5, the electrical property being measured, by means of a conventional electrical circuit, is, in an embodiment, a value of resistance. In a further embodiment, the electrical property being measure is a value of capacitance. In a further embodiment, both resistance and capacitance are measured and a complex impedance measurement takes place. It is appreciated that other electrical properties may be measured if this is suitable for the active material in question.

It is noted that the schematic of FIG. 7 does not illustrate the encapsulant 601, however it is appreciated that the mechanism described with respect to FIGS. 7 and 8 is substantially similar whether an encapsulant is included in the force sensing device or not.

In the embodiment, the orientation of groove 202A in relation to force 701 means that groove 202A faces towards the center of curvature of force 701 when the force is applied. Thus, when force 701 is applied to the top surface of active material 501, substrate 201 is configured to bend as active material 501 deforms to provide the change in electrical property. The change in electrical property can then be measured across electrodes 401 and 402 in a conventional manner. The electrical property changes in line with the deformation changes of the active material to provide variations of the electrical property in response to the change in applied force. In addition, the bending of the substrate and distance between the electrodes may be measured as an additional response.

### FIG. 8

Applied force 701 provides a deformation to the force sensing device and specifically active material 501 and substrate 201, as shown in the schematic of FIG. 8. As force 701 is applied to an upper surface 801 of the force sensing device in the manner shown, active material 501 compresses, substrate 201 bends, distance 303 reduces and electrodes 401 and 402 move closer together.

When force 701 is applied to the force sensing device as described herein the response of the force sensing device is dependent on the orientation of the at least one groove. If the groove or grooves face toward the center of curvature of applied force 701, active material 501 within the grooves is compressed and electrodes 401 and 402 move closer together, reducing distance 303 as the force sensing device adopts the curvature of the upper surface 801 of the force sensing device. When a further surface is present on the underside of the force sensing device, active material 501 receives a compressive force which is magnified by the stress concentrating groove 202A of substrate 201.

In an alternative embodiment to that illustrated, for example if force 701 was applied from the underside 802 of the force sensing device, thereby ensuring that groove 202A faced in the opposite direction to the center of curvature of the force sensing device, then as the flexible substrate 201 bends in response to the applied force, distance 303 increases and the faces of groove 202A move away from each other. Active material 501 is therefore placed in tension.

The stress placed on active material 501 under applied force 701 and the change in distance 303 between and orientation of electrodes 401 and 402 as the force sensing device deforms can be used to transduce the applied force 701 into a measurable electrical property, such as resistance or capacitance as described previously. Unlike conventional force sensing devices, a “B” surface is not required to provide a reactant force to the applied force; instead, it is the curvature of the substrate comprising at least one groove which provides the output signal for measurement. This therefore provides a simplified procedure for integrating the force sensing device into an electronic device, such as that described in FIG. 1, which is less sensitive to manufacturing tolerances. Thus, a force sensing device in accordance with the present invention, for example, integrated into a flexible display or a keyboard or trackpad, can be securely adhered to a single surface (i.e., the “A” surface). This reduces the constraints of accurate and precise mechanical integration with the conventional “B” surface making the manufacturing and assembly process easier and increases reproducibility.

The at least one groove or plurality of grooves each act as a stress concentrator. The stress concentration about each groove ensures that the active material is deformed to a greater degree for a given applied force. Thus, each groove magnifies local stresses when subjected to a mechanical load such as an applied force. This increased local stress around the grooves themselves consequently increases the sensitivity of the force sensing device.

The described force sensing device provides a further advantage over conventional planar force sensing devices in that, because in conventional devices the upper layer and lower layers are required to make contact to provide an output signal, it is often necessary to include an air gap or spacer to reduce the effects in manufacture of pre-load or variations from device to device. The claimed invention does not require an air gap, nor is it dependent on the manufacture as the applied force is only measured in response to the deformation of the active material, rather than due to compression of the air gap, for example. This in turn allows the force sensing device to be more consistently integrated into an electronic device.

The invention claimed is:

1. A force sensing device, comprising:
a first electrode and a second electrode;
a substrate comprising at least one groove; and
an active material between said first electrode and said second electrode; wherein
said at least one groove comprises a first face and a second face inclined to said first face, and said first face and said second face are arranged a distance apart from each other;
said first electrode is deposited on said first face and said second electrode is deposited on said second face;
said distance is configured to change on application of an applied force to deform said active material and provide a change in an electrical property of said active material; and
said substrate comprises a flexible non-conductive material.

2. The force sensing device of claim 1, wherein said electrical property is at least one of the following:
a change in resistance; or a change in capacitance.

3. The force sensing device of claim 1, wherein said active material comprises any one of the following:
a piezoresistive composite material; a quantum tunnelling material; a conductive foam; a mesh of conductive elastomeric fibers; a dielectric material; an elastomer; an elastomeric foam; or a substantially porous material.

4. The force sensing device of claim 1, wherein said at least one groove is formed by an embossing process.

5. The force sensing device of claim 1, wherein at least one of said first electrode or said second electrode comprises any one of the following:
a conductive material; a metallic material; aluminum; titanium; or copper.

6. The force sensing device of claim 1, wherein each of said first electrode and said second electrode is deposited by means of any one of the following:
a physical vapor deposition process; an evaporation process; a pulse laser deposition process; or molecular beam epitaxy.

7. The force sensing device of claim 1, further comprising an encapsulant configured to prevent contamination of said force sensing device.

8. The force sensing device of claim 7, wherein said encapsulant comprises an adhesive.

9. The force sensing device of claim 7, wherein said encapsulant comprises any one of the following:
an ultraviolet (UV) curable material; a thermally curable material; or a polymer resin.

10. An electronic device comprising the force sensing device of claim 1.

11. A method of manufacturing a force sensing device, comprising the steps of:
forming a substrate comprising at least one groove comprising a first face and a second face inclined to said first face, said first face and said second face positioned a distance apart from each other;
depositing a first electrode on said first face;
depositing a second electrode on said second face; and
applying an active material between said first electrode and said second electrode, such that, in use, on application of an applied force, said distance changes and deforms said active material to provide a change in an electrical property of said active material; wherein
said substrate comprises a flexible non-conductive material.

12. The method of claim 11, wherein said step of forming said substrate comprises forming said at least one groove by an embossing process.

13. The method of claim 11, further comprising the step of:
integrating said force sensing device into an electronic device.

14. The method of claim 11, wherein at least one of said depositing said first electrode step or said depositing said second electrode step comprises any one of the following:
a physical vapor deposition process; an evaporation process; a pulse laser deposition process; or molecular beam epitaxy.

15. The method of claim 11, further comprising the step of:
applying an encapsulant to an upper surface of said active material.
